(19) United States
(12) Patent Application Publication
(10) Pub. No.: US 2020/0296147 A1
(43) Pub. Date: Sep. 17, 2020

(54) SYSTEMS AND METHODS FOR REAL-TIME COLLABORATION

(71) Applicant: Oblong Industries, Inc., Los Angeles, CA (US)

(72) Inventors: Eben Eliason, Los Angeles, CA (US); Kate Davies, Los Angeles, CA (US); Sean Weber, Los Angeles, CA (US); Mark Backman, Los Angeles, CA (US); Carlton J. Sparrell, Los Angeles, CA (US); John Stephen Underkoffler, Los Angeles, CA (US)

(21) Appl. No.: 16/818,725

(22) Filed: Mar. 13, 2020

Related U.S. Application Data
(60) Provisional application No. 62/818,959, filed on Mar. 15, 2019.

(51) Int. Cl. H04L 29/06; G06F 3/0481

(52) U.S. Cl. CPC H04L 65/4053; G06F 3/04812; H04L 65/1089

(57) ABSTRACT

Systems and methods for real-time collaboration using multiple content streams.

### CROSS-REFERENCE TO RELATED APPLICATIONS

This application claims priority to U.S. Provisional Application No. 62/818,959 filed 15 Mar. 2019, which is incorporated herein in its entirety by this reference.

### TECHNICAL FIELD

This invention relates generally to the communication field, and more specifically to new and useful systems and methods for real-time collaboration in the communication field.

### BACKGROUND

There is a need in the communication field to create a new and useful system and method for real-time collaboration. This invention provides such new and useful systems and methods.

### BRIEF DESCRIPTION OF THE FIGURES

FIG. 1 is a schematic representation of a system, in accordance with embodiments.

FIG. 2A-D are a flowchart representations of a method, in accordance with embodiments.

FIGS. 3A-G are a schematic representations of exemplary user interfaces.

FIGS. 4-6 are representations of a method, in accordance with embodiments.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. OVERVIEW

Embodiments herein include systems and methods for content collaboration.

### 2. BENEFITS

Variations of this technology can afford several benefits and/or advantages.

First, variations of the technology can result in improved collaboration by allowing multiple collaboration participants to share static and dynamic content.

Second, variations of the technology can result in improved collaboration by allowing participants to arrange content elements provided by different participants in a single display area.

Third, variations of the technology can result in improved collaboration by allowing participants to see what content each participant is viewing at any moment.

Fourth, variations of the technology can result in improved collaboration by allowing participants to express sentiments using visual indicators without interrupting a spoken presentation.

Fifth, variations of the technology can result in improved collaboration by allowing participants to shift focus of a collaboration session to a particular content element.

Sixth, variations of the technology can result in improved collaboration by automatically detecting and sharing an emotion of each participant.

Seventh, variations of the technology can improve network utilization by streaming selected content elements of the collaboration session and providing static representations of other content elements.

### 3. SYSTEM

The system can be any suitable type of system that functions to provide multi-user collaboration. Multi-user collaboration can include receiving content from one or more content sources, displaying received content on one or more display devices, and manipulating displayed content (or an application) based on input received from one or more input sources.

Variations of the system include multi-tenant system and single-tenant systems.

The system can be an on-premises system, a cloud-based system, or any combination thereof. For example, the system can be a local server that provides multi-user collaboration, a cloud-based collaboration platform, or a system that interfaces with one or more on-premises collaboration servers via a cloud-based system. However, the system can be otherwise configured.

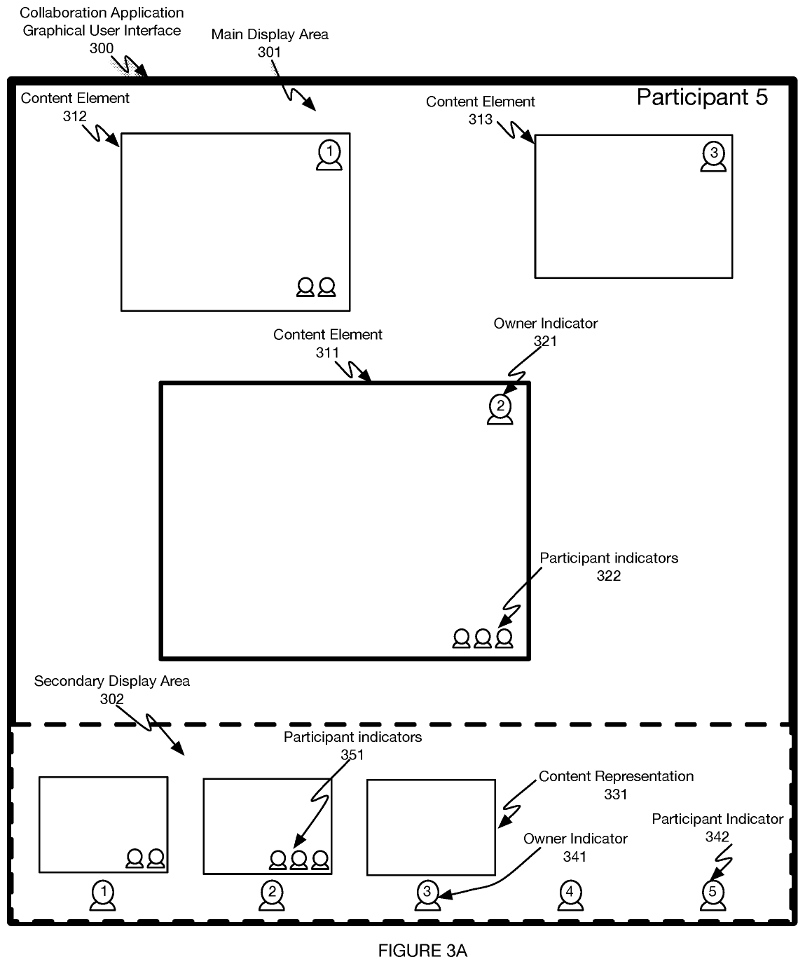

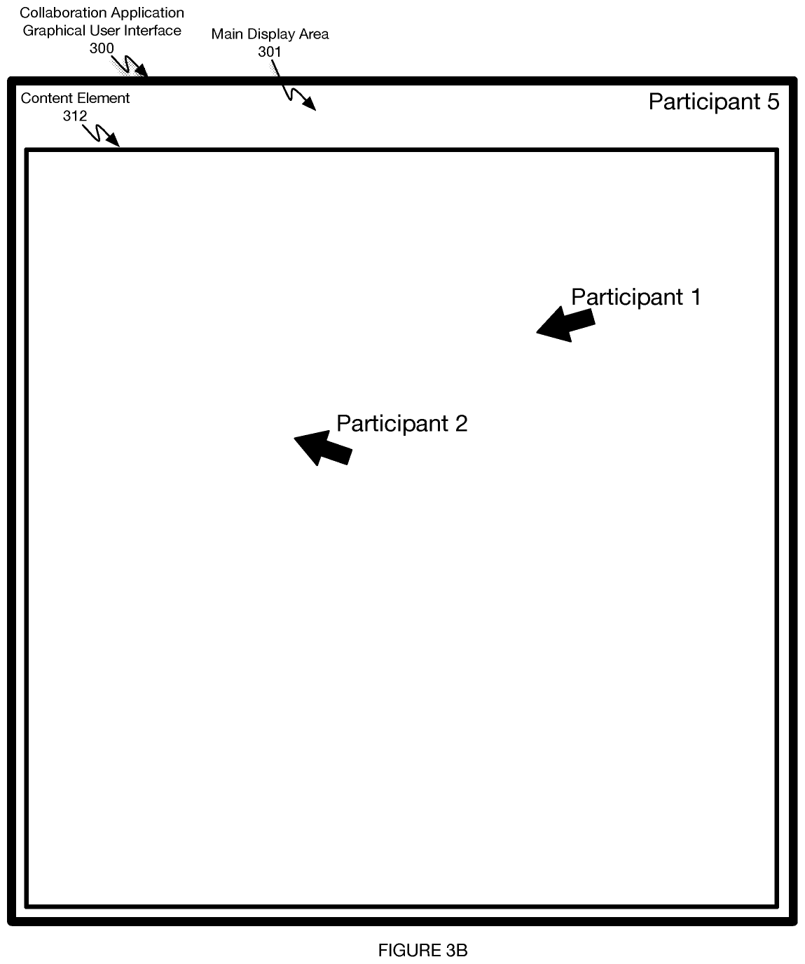

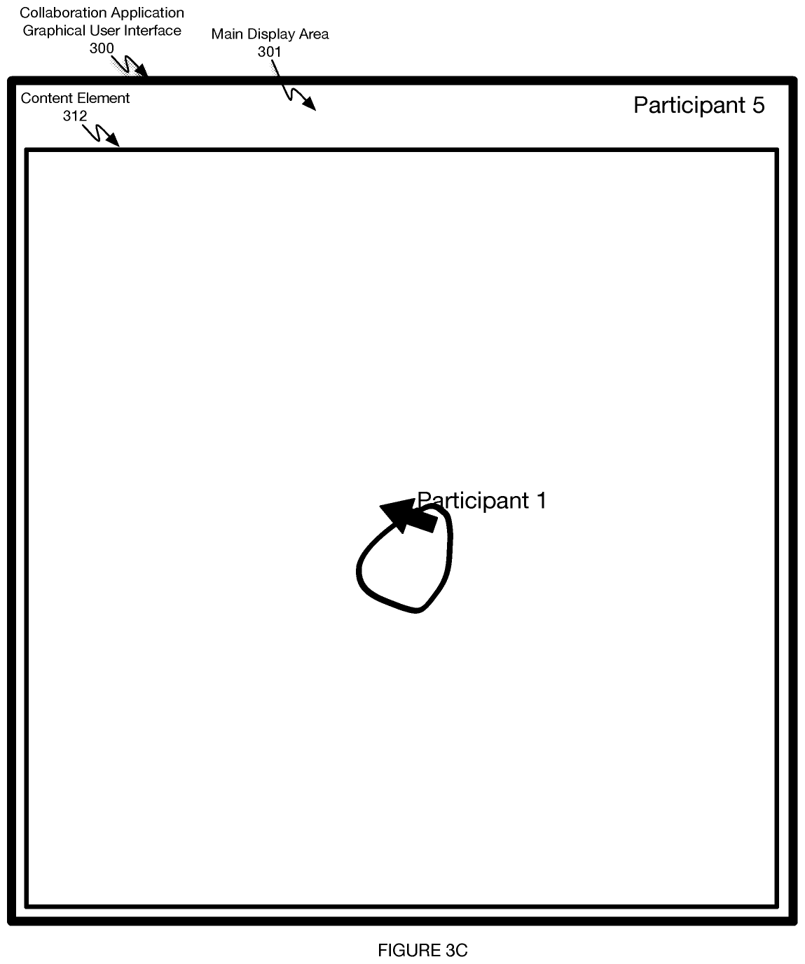

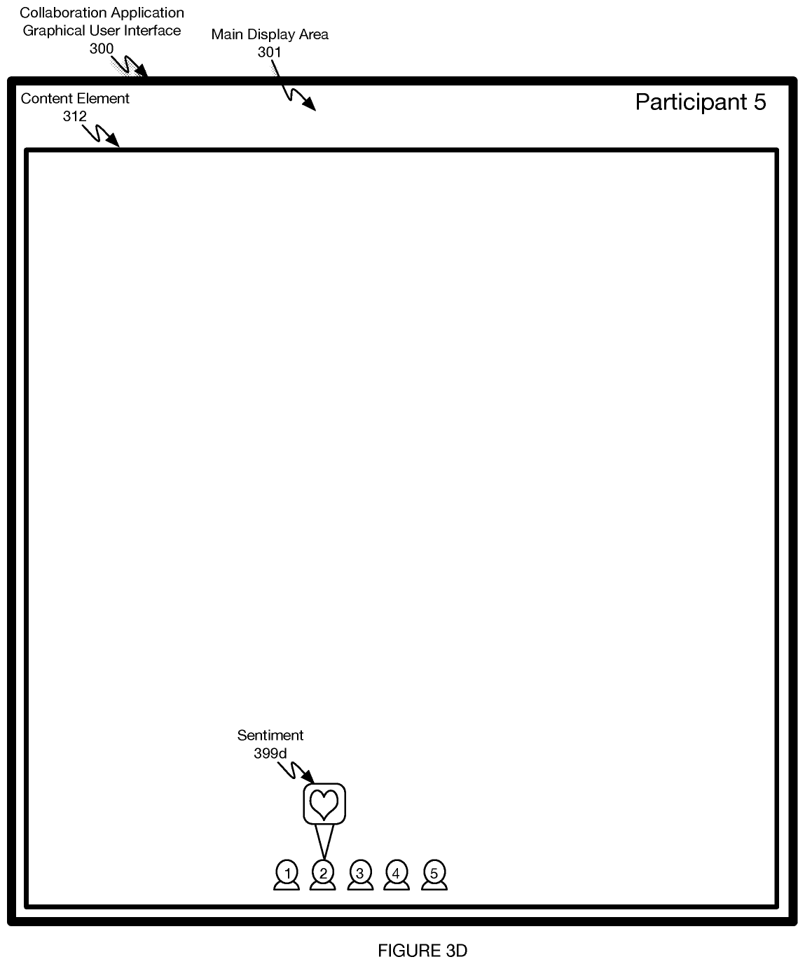

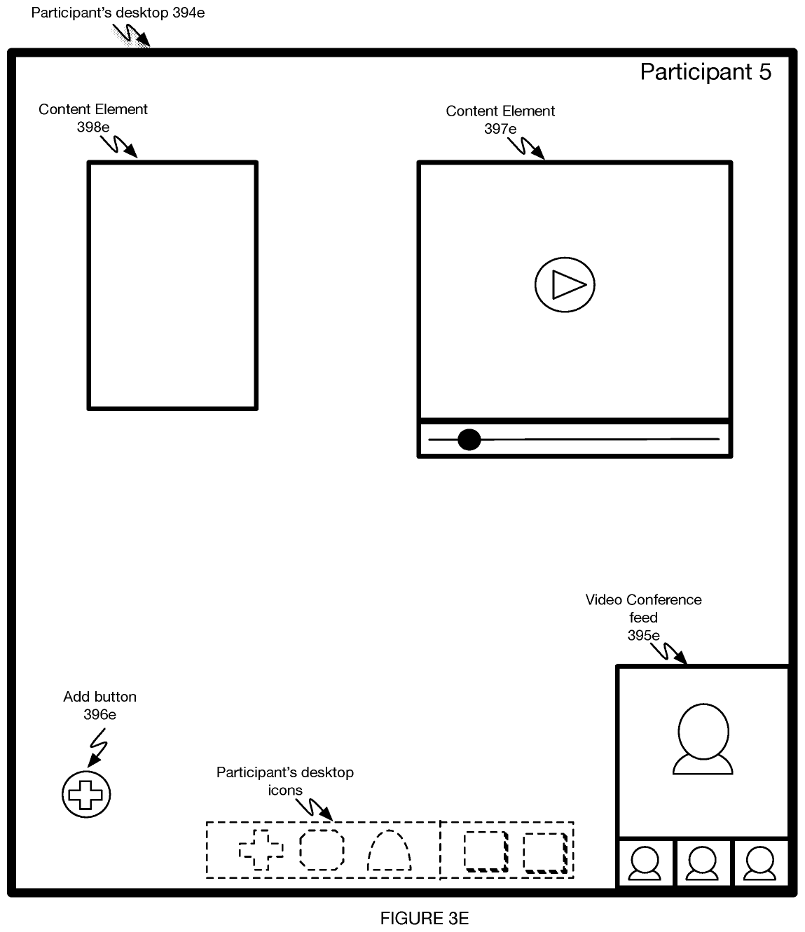

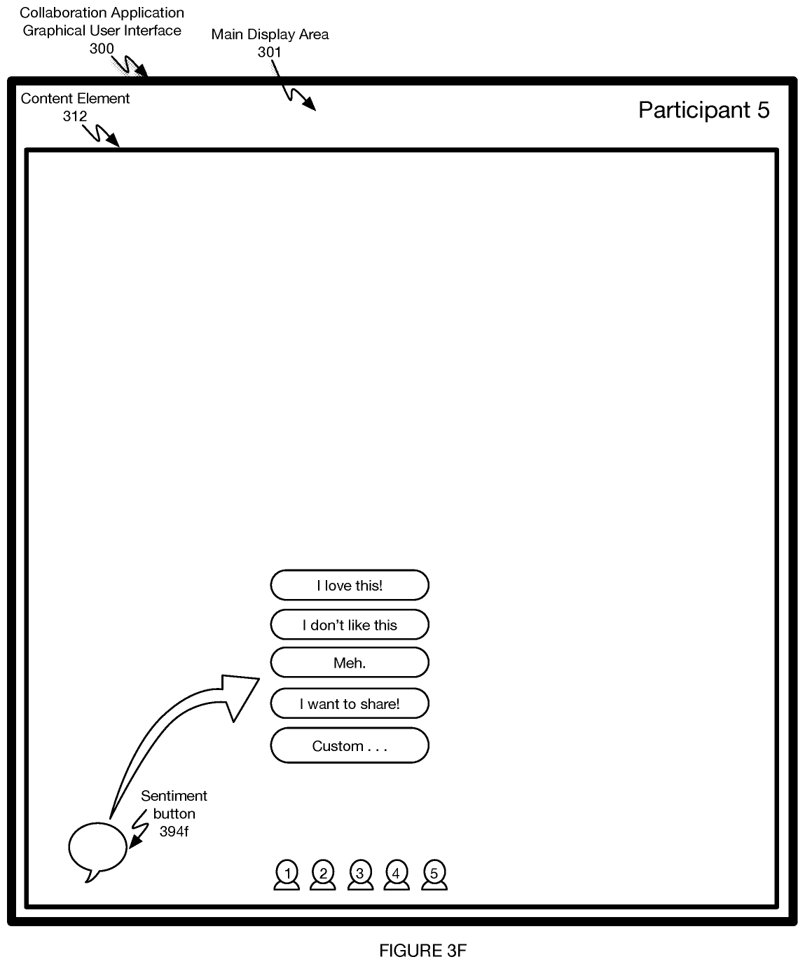

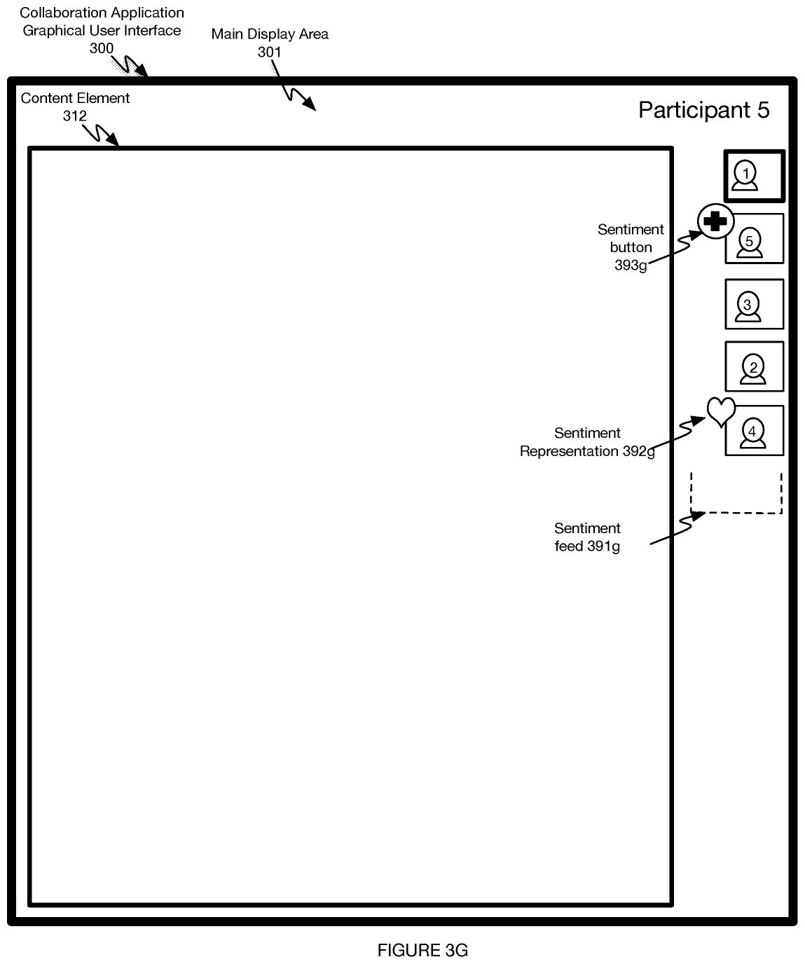

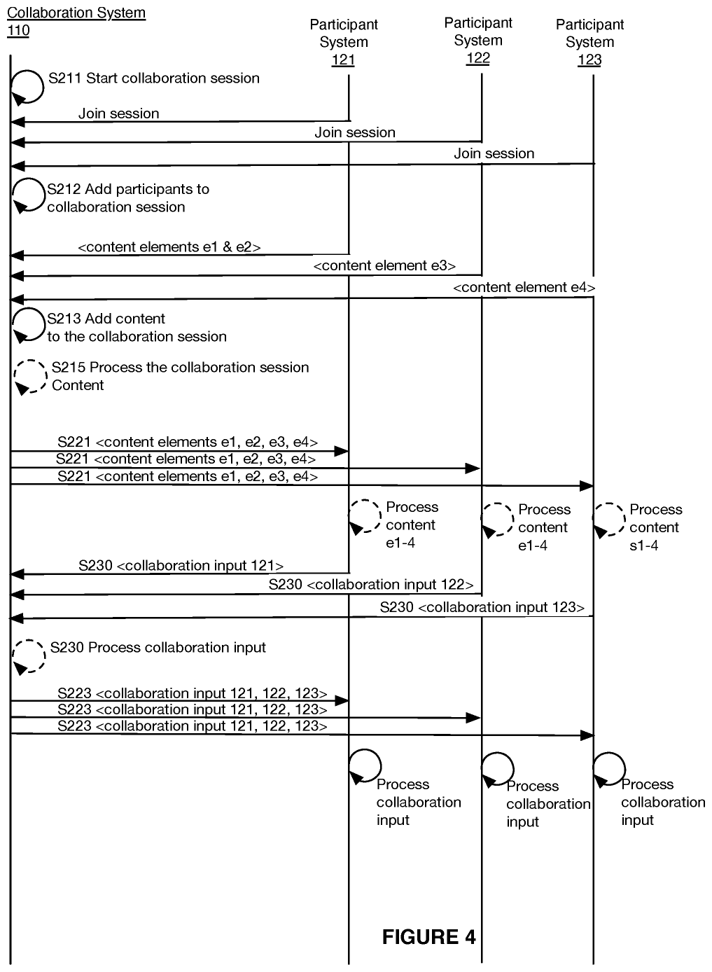

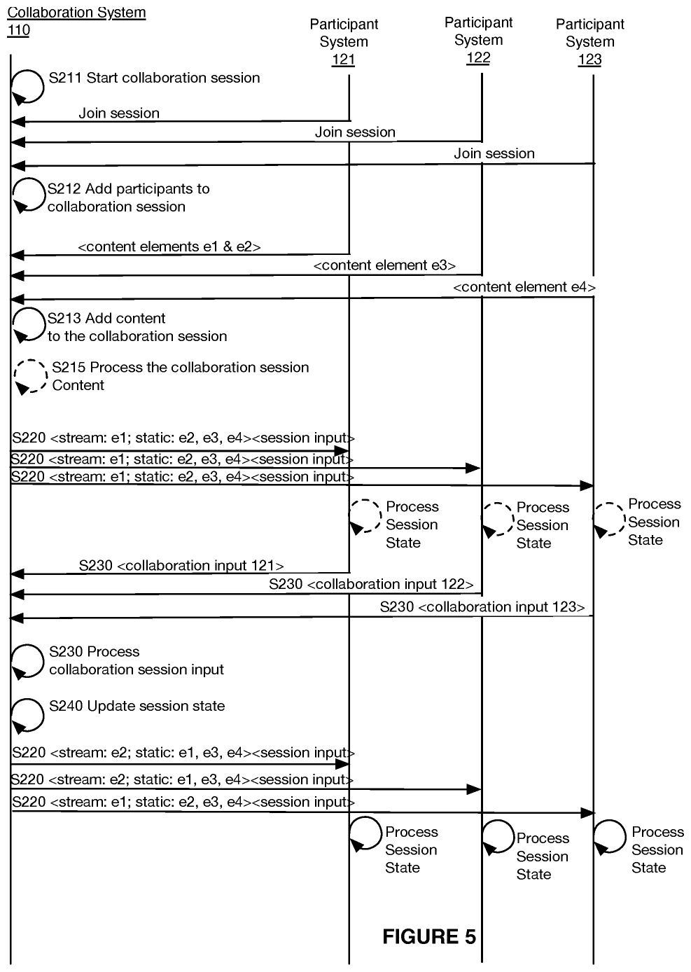

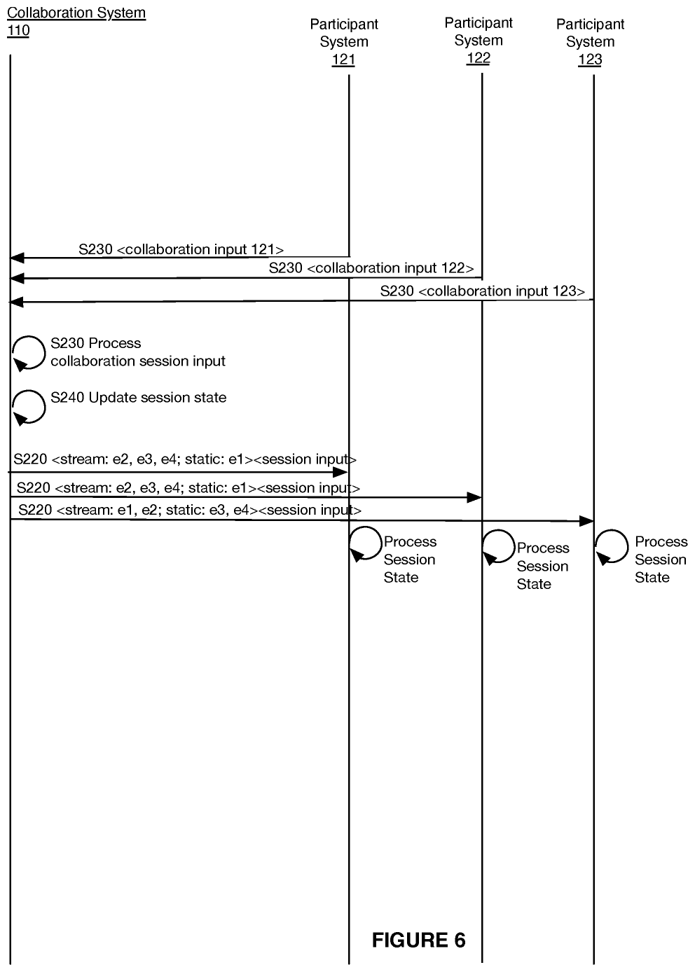

In some variations, the system manages one or more collaboration sessions. Each collaboration session can have one or more participants, and session content (collaboration session content). In some variations, the collaboration session content includes one or more elements of content (content elements) (e.g., 311-313 shown in FIG. 3A, 397e and 398e shown in FIG. 3E, content elements e1-e4 shown in FIG. 4, etc.).

In some variations, content elements include static content elements and dynamic content elements. In some variations, static content elements include images, and the like. In some variations, dynamic content elements include content streams. In some implementations, content streams include one or more of: a video stream, an audio stream (e.g., voice chat, music, etc.), a screen share stream, a system screen capture stream, an application output stream, a video camera stream, a data stream from a data source (e.g., a sensor, an IoT device, etc.). However, collaboration session content can include any suitable type of content elements.

In some variations, the system can receive content elements from local storage, one or more participant systems, remote storage, remote systems, sensors, or any suitable content source or system.

The system can display output (e.g., received content elements, output generated from received content elements, etc.) on a single display device (e.g., a device viewed by multiple participants simultaneously) or on multiple display devices (e.g., a multi-display system included in a room, a display wall formed by multiple display devices, display devices included in participant systems, etc.).

The system can receive session input from one or more participant systems (e.g., client user devices, such as mobile devices, laptops, wands, user input devices, and the like), one or more on-premises collaboration systems (e.g., an in-room collaboration server that provides collaboration among participants co-located in a single room), and the like. The system can optionally receive 3-space input from one or more tracking systems that function to generate 3-space coordinates (e.g., in a coordinate space of a room) by tracking one or more objects (e.g., wands, tags, hands, faces, etc.).

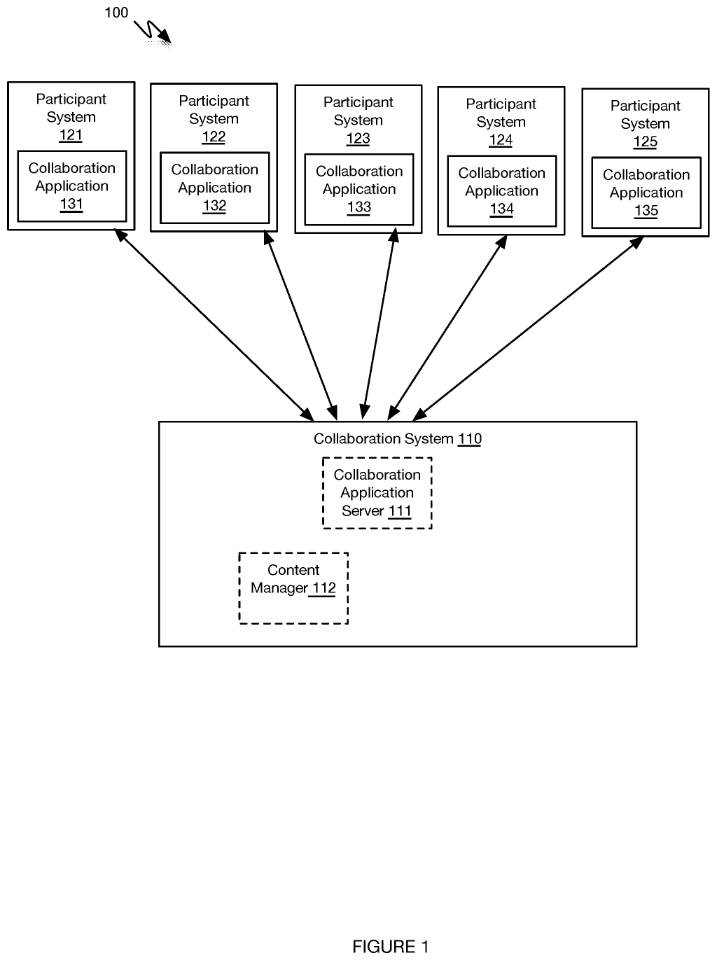

In some variations, the system 100 includes the collaboration system 110 and at least one participant system (e.g., 121-125) (as shown in FIG. 1).

The collaboration system functions to manage at least one collaboration session for one or more participants. In some variations, the collaboration system 110 includes one or more of a CPU, a display device, a memory, a storage device, an audible output device, an input device, an output device, and a communication interface. In some variations, one or more components included in the collaboration system 110 are communicatively coupled via a bus. In some variations, one or more components included in the collaboration system 110 are communicatively coupled to an external system (e.g., 121-125) via the communication interface.

The communication interface functions to communicate data between the collaboration system and another device (e.g., a participant system 121-125). In some variations, the communication interface is a wireless interface (e.g., Bluetooth, WiFi, LTE, GSM, etc.). In some variations, the communication interface is a wired interface (e.g., USB, Ethernet, HDMI, etc.). In some variations, the communication interface is a radio transceiver.

The input device functions to receive user input. In some variations, the input device includes at least one of buttons and a touch screen input device (e.g., a capacitive touch input device).

In some variations, the collaboration system 110 includes one or more of a collaboration application server (e.g., 111 of FIG. 1) and a content manager (e.g., 112 of FIG. 1). In some variations, the collaboration application server 111 functions to receive collaboration input from one or more collaboration applications (e.g., 131-135) (running on participant systems, 121-125). In some variations, the collaboration application server 111 functions to provide each collaboration application (e.g., 131-135) of a collaboration session with initial and updated collaboration session state of the collaboration session. In some variations, the collaboration application server 111 manages session state for each collaboration session.

In some variations, the content manager 112 functions to manage content elements (e.g., provided by a collaboration application 131-135, stored at the collaboration system 110, stored at a remote content storage system, provided by a remote content streaming system, etc.). In some variations, the content manager 112 provides content elements for one or more collaboration sessions. In some variations, the content manager 112 functions as a central repository for content elements (and optionally related attributes) for all collaboration sessions managed by the collaboration system 110.

Each participant system (e.g., 121-125) functions to execute machine-readable instructions of a collaboration application (e.g., 131-135). Participant systems can include one or more of a mobile computing device (e.g., laptop, phone, tablet, wearable device), a desktop computer, a computing appliance (e.g., set top box, media server, smart-home server, telepresence server, etc.), a vehicle computing system (e.g., an automotive media server, an in-flight media server of an airplane, etc.). In some variations, each participant system includes one or more of a camera, an accelerometer, an Inertial Measurement Unit (IMU), an image processor, an infrared (IR) filter, a CPU, a display device, a memory, a storage device, an audible output device, an audio sensing device, a haptic feedback device, sensors, a GPS device, a WiFi device, a biometric scanning device, an input device. In some variations, one or more components included in a participant system are communicatively coupled via a bus. In some variations, one or more components included in a participant system are communicatively coupled to an external system (e.g., the collaboration system 110) via the communication interface of the participant system. In some variations, the collaboration system 110 is communicatively coupled to at least one participant system. In some variations, the storage device includes the machine-readable instructions of a collaboration application (e.g., 131-135). In some variations, the collaboration application is a stand-alone application. In some variations, the collaboration application is a browser plug-in. In some variations, the collaboration application is a web browser.

In some variations, each collaboration application (e.g., 131-135) includes one or more of a content module and a collaboration module. In some variations, each module of the collaboration application is a set of machine-readable instructions executable by a processor of the corresponding participant system to perform processing of the respective module.

In some variations, each collaboration application (e.g., 131-135) functions to interact with the collaboration system 110 to provide multi-user and multi-stream collaboration during a collaboration session hosted by the collaboration system 110.

In some variations, collaboration applications function to control display of information (e.g., content elements) received from the collaboration server (for the collaboration session) at a display device of the respective participant system, and receive user input from a participant of the collaboration session via a user interface device of the participant system.

In some variations, each collaboration application generates a graphical user interface (e.g., 300 shown in FIG. 3A) that includes a main display area (e.g., 301 shown in FIG. 3A). In some variations, the collaboration application includes a single content element of the collaboration session in the main display area (e.g., a single content element of a selection set of the respective participant, as identified by information received form the collaboration system 110). In some variations, the collaboration application includes two or more content elements (e.g., 311, 312, 313 shown in FIG. 3A) of the collaboration session in the main display area (e.g., each content element of a selection set for the respective participant, as identified by information received form the collaboration system 110). In some variations, the main display area (e.g., 301) functions according to a desktop metaphor and the collaboration application provides WSYIWYG (What You See Is What You Get) arrangement of content elements of the selection set within the main display area (e.g., sizing of content elements, location of content elements within the display area, etc.).

In some variations, the graphical user interface (e.g., 300) includes at least one visual indicator (e.g., 322 shown in FIG. 3A) identifying a number and/or identities of participants viewing a content element (e.g., 311) included in the main display area (e.g., 301). In some variations, the graphical user interface includes at least one visual indicator (e.g., 321 shown in FIG. 3A) identifying an owner of a content element (e.g., 311) included in the main display area.

In some variations, in a case where several content elements are displayed in the main display area, the collaboration application displays a visual indicator (e.g., a highlighted boarder) indicating a content element selected as a focused element (e.g., selected by a participant to be a focus element, or automatically selected by the collaboration system based on collaboration session context). As shown in FIG. 3A, content element 311 is displayed with a highlighted boarder, indicating that it has focus. In some variations, in a case where the main display area (e.g., 301) includes multiple content elements, any participant can select a content element to cause the collaboration system 110 to control the main display areas of other participants (viewing the same arrangement of content elements) to highlight the selected content element.

In some variations, the collaboration application (e.g., 131-135) includes a secondary display area (e.g., 302 shown in FIG. 3A) in the graphical user interface (e.g., 301). In a first variation, the main display area and the secondary display area are displayed in separate regions of the graphical user interface. In a second variation, the secondary display area (e.g., 302 shown in FIG. 3A) is overlaid on top of the main display area (e.g., 301 shown in FIG. 3A).

In some variations, the secondary display area includes content representations (e.g., 331 shown in FIG. 3A) of at least one content element of the collaboration session (as indicated by the information received from the collaboration system 110 in S220). In some variations, one or more of the content representations are static representations (e.g., images, icons, thumbnails, textual descriptions, etc.). In some variations, one or more of the content representations are dynamic representations (e.g., streams, reduced resolution streams, reduced size streams, animated images, etc.).

In some variations, the secondary display area includes content representations for each content element of the collaboration session. In some variations, the secondary display area includes content representations for a subset of the content elements of the collaboration session. In a first example, the secondary display area includes content representations for a subset of content elements selected for display in the secondary display area. In a second example, the secondary display area includes content representations for all content elements not selected for display in the main display area. In some variations, the secondary display area includes content representations of one or more content elements included in a static set of content elements that includes stream content elements that have not been selected for streaming. In some variations, content representations of content elements included in the static set are static representations. In some variations, content representations of content elements included in the static set include one or more of animated images, reduced resolution streams, and reduced size streams. In this manner, network resources can be more efficiently utilized by reducing an amount of data transmitted to participants for content elements included in the static set.

In some variations, the graphical user interface (e.g., 300) includes at least one visual indicator (e.g., 351 shown in FIG. 3A) identifying a number and/or identities of participants viewing a content representation (e.g., 331) included in the secondary display area. In some variations, the graphical user interface includes at least one visual indicator (e.g., 341 shown in FIG. 3A) identifying an owner of a content element (e.g., 331) included in the secondary display area. In some variations, the graphical user interface includes other visual indicators for content representations included in the secondary display area. Visual indicators displayed for content representations in the secondary display area (e.g., 302) can include visual indicators for one or more of sentiments, reactions, votes and annotations. Visual indicators displayed for content elements in the main display area (e.g., 301) can also include visual indicators for one or more of sentiments, reactions, votes and annotations.

In some variations, the graphical user interface includes a visual indicator that identifies each participant of the collaboration session (e.g., 341, 342).

As shown in FIG. 3A, the exemplary graphical user interface 300 includes a main display area 301 and a secondary display area 302. The main display area includes three content elements, 311-313. A visual indicator of the owner of each content element is displayed in the top right corner of each content element. A visual indicator for each viewing participant is displayed in the bottom right corner of each content element. The secondary display area 302 includes a content representation (e.g., a thumbnail) for each content element of the collaboration session. As shown in FIG. 3A, there are three content elements in the collaboration session. A visual indicator of the owner of each content element is displayed below each content representation. A visual indicator for each viewing participant is displayed in the bottom right corner of each visual representation in the secondary display area 302. A visual indicator for each participant of the collaboration session is displayed in the secondary display area 302 shown in FIG. 3A. As shown in FIG. 3A, there are five participants (participants 1-5), participant 1 is sharing a content element with two viewing participants, participant 2 is sharing a content element with three viewing participants, participant 3 is sharing a content element with no viewing participants, and participants 4 and 5 are not sharing content. As shown in FIG. 3A, all content elements of the collaboration session are displayed in the main display area 301. In some variations, the content elements in the main display area can be removed from the main display area, and content elements represented in the secondary display area can be added to the main display area (e.g., by a drag-and-drop user input operation). In some variations, the collaboration application (e.g., 131-135) enables and disables display of the secondary display area based on one or more of session context or user input. In some variations, a participant can provide user input to remove the secondary display area from the user interface, or provide user input to add the secondary display area to the user interface. In some variations, the secondary display area automatically vanishes during an event, such as, for example, an annotation event, an expiration of a predetermined amount of time, and the like. In some variations, the content representations of the secondary display area can be overlaid on top of each other in a stacked arrangement. In some variations, a stacked arrangement of content representations can be expanded to display each content representation separately, in response to a user input.

In some variations, the content representations (e.g., 331 shown in FIG. 3A) included in the secondary display area are organized based on one or more of: number of participants viewing the respective content elements, how recently the respective content elements were added, how recently the content elements were focused, and the like. However, the content representations included in the secondary display area can be organized based on any suitable criteria.

### 4. METHOD

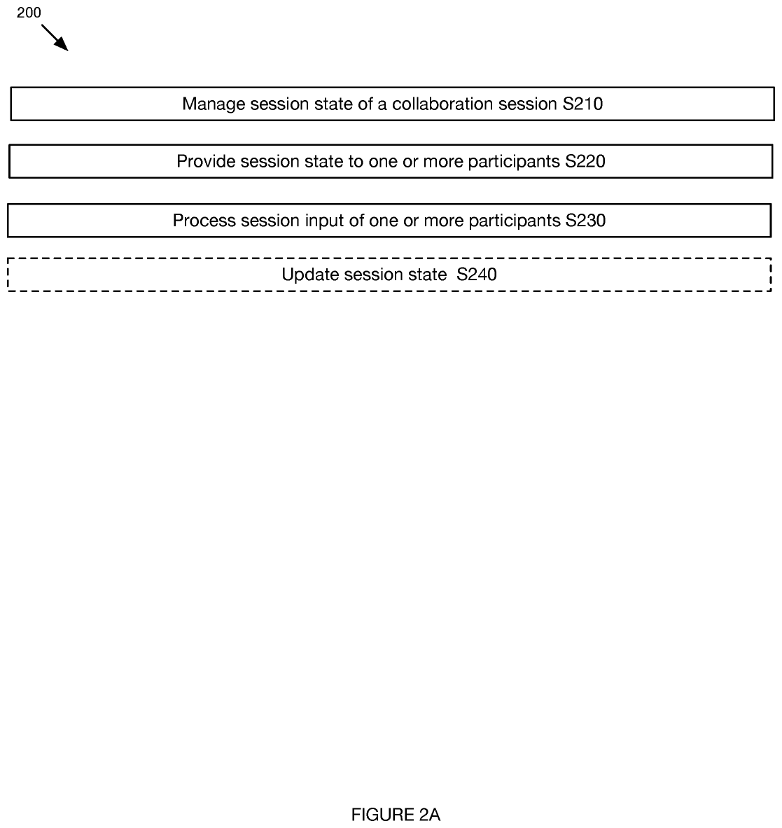

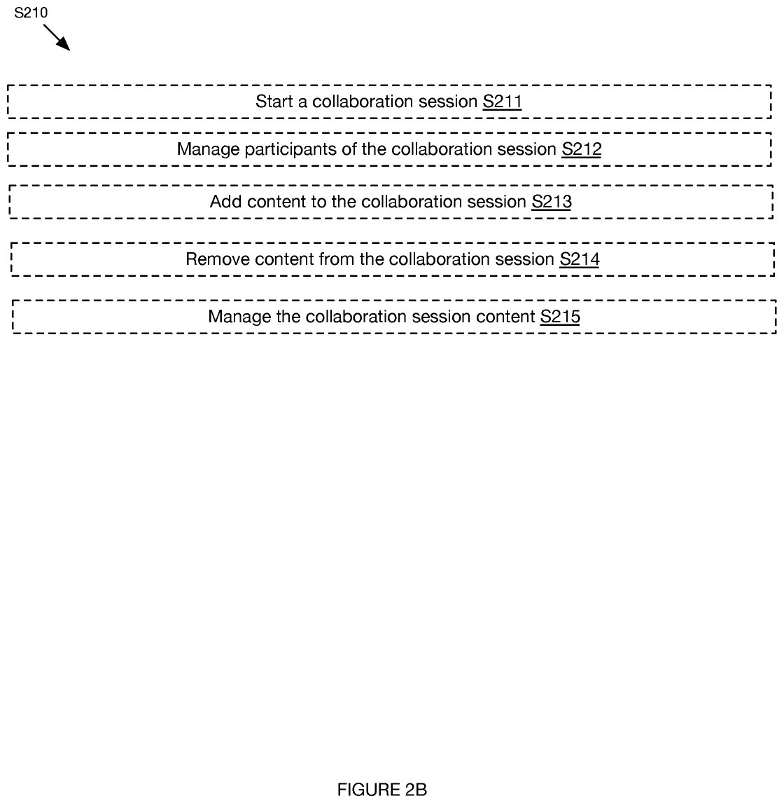

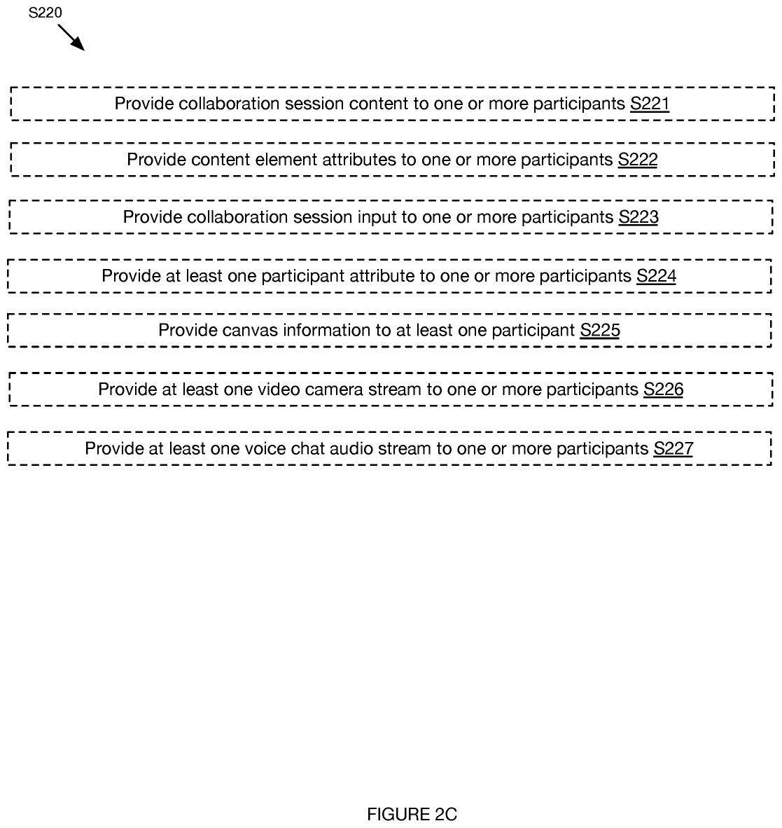

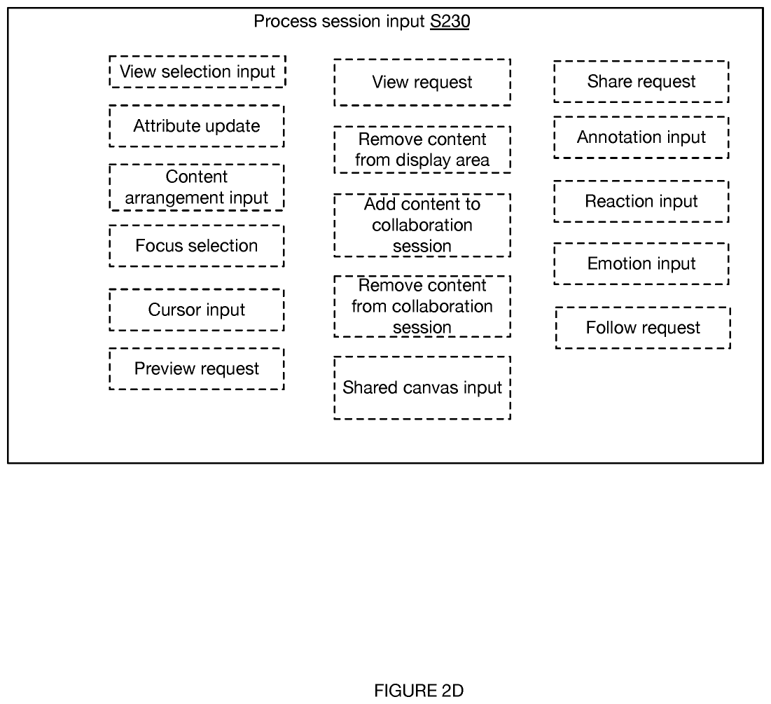

As shown in FIGS. 2A-B, and 4-6, the method 200 includes at least one of: managing session state of a collaboration session S210; providing session state to one or more participants S220; processing session input of one or more participants S230; and updating session state S240.

In some variations, S210 includes one or more of: starting a collaboration session S211; managing participants of the collaboration session S212; adding collaboration session content to the collaboration session S213; removing content from the collaboration session S214; and managing the collaboration session content S215. S212 can include one or more of: adding at least one participant to the collaboration session; and removing at least one participant from the collaboration session.

In some variations, S220 includes one or more of: providing collaboration session content to one or more participants S221; providing at least one content element attribute to one or more participants S222; providing collaboration session input to one or more participants S223; providing at least one participant attribute to one or more participants S224; providing canvas information to one or more participants S225; providing at least one video camera stream to one or more participants S226; and providing at least one voice chat audio stream to one or more participants S227. However, S220 can include providing any suitable type of session state to one or more participants.

In some implementations, providing the session state and/or session input to participants includes providing the session state and/or session input to respective participant systems (e.g., 121-125) (and optionally respective collaboration applications 131-135).

S230 can include one or more of: receiving session input of at least one participant from a respective participant system; accessing session input of at least one participant; transforming session input of at least one participant; and performing an action based on session input of at least one participant.

In some variations, at least one component of the system 100 performs at least a portion of the method 200.

In some variations, S10-S240 (and optionally sub-processes included in S210-S240), can be performed in any suitable order.

As an example, S212 can be performed initially to add participants to a new collaboration session, or can be performed at any suitable time to add or remove participants during a collaboration session. As another example, S213 can be performed initially to add contents to a new collaboration session, or can be performed at any suitable time to add content during a collaboration session. As another example, S230 can be performed at any time during a collaboration session (e.g., to receive session input provided by a participant system during the collaboration session). As another example, S210 can be performed at any time, for example, to remove content from a collaboration session. As another example, S240 can be performed in response to changes in collaboration session state (e.g., change in content, receipt of session input, change in participants, etc.).

The method 200 can be performed for a plurality of collaboration sessions.

In some variations, the method functions to enable sharing of multiple content elements during a collaboration session among multiple participants. In an example, a collaboration system (e.g., no) can receive content elements from one or more participants (via respective participant systems, e.g., 121-125), and provide one or more of the received content elements to one or more participants. In some variations, the content elements include one or more video camera streams, and the collaboration system provides video conferencing by distributing received video camera streams to the participants. In some variations, the content elements include one or more microphone audio streams, and the collaboration system provides voice chat by distributing at least one voice chat audio stream (e.g., individual microphone audio streams, a combined voice chat audio stream generated by combining microphone audio streams received from the participants, etc.) to the participants.

In some variations, content elements can be selectively provided (e.g., by the collaboration system) to participant systems. By virtue of the collaboration system selectively providing content elements (e.g., streams), rather than streaming all content elements received by the collaboration system to each participant, network (and computing resources) can be more efficiently utilized.

In some variations, the collaboration system provides selected content element streams; for stream content elements that are not selected, the collaboration system provides static representations of such content elements to the participants. In a first example, the collaboration system provides one or more voice chat streams to participants, in addition to selected content element streams. In a second example, the collaboration system provides one or more video conference streams to participants, in addition to selected content element streams. In a third example, the collaboration system provides only selected content element streams to participants.

In a first variation, each participant receives the same selection of content element streams. In a second variation, the collaboration system determines a selection of content element streams for each participant, and provides each participant with its respective selection of content element streams.

In some variations, selection of content element streams is performed based on collaboration session state. In a first example, the collaboration system 110 selects content element streams based on one or more of: a number of viewers viewing each content element, a shared focus of the collaboration session, a private focus of the collaboration session, content elements being viewed by a host of the collaboration session, content elements being shared by the host of the collaboration session, content elements being viewed by a current speaker, content elements being shared by a current speaker, etc. However, the collaboration system 110 can perform any suitable process for selecting content element streams (stream content elements).

In some variations, selection of content element streams is performed based on collaboration session input received from one or more participants (via a respective participant system). In some variations, collaboration session input used to select content element streams includes one or more of the following from one or more participants: input selecting un-selected content elements, input de-selecting selected content elements, input identifying a sentiment for a content element, input identifying an annotation to a content element, input identifying pointer location of at least one participant, etc.

In a first example, a participant may arrange one or more content elements in a main display area (e.g., 301 shown in FIG. 3A), and the collaboration system streams content elements arranged in the main display area to the participant, while sending static (or reduced) representations (e.g., 331) of content elements arranged in a secondary display area (e.g., 302). In some variations, each participant can independently arrange content elements in the main display area of the user interface (e.g., 300) displayed by their respective participant system.

In a second example, the collaboration system streams content elements annotated by one or more participants (e.g., to all participants, to a group of participants, to annotating participants, etc.).

However, content elements can otherwise be selectively streamed to participant systems.

S211 functions to start a collaboration session.

In some variations, S212 can include adding one or more participants to the collaboration session. S212 can be performed at any time, such as at the start of the collaboration session, during a collaboration session, in response to a trigger event, etc. S212 can include removing one or more participants from the collaboration session (e.g., during a collaboration session, at the end of the collaboration session, etc.). As shown in FIG. 4, participants can join a session, by controlling a participant system to send a join-session request to the collaboration system 110, and the collaboration system can add participants to the session based on information provided by the join-session requests.

In some variations, S212 includes managing participants of the collaboration session by maintaining a participant data structure for the collaboration session that includes identities of each participant of the collaboration session. In some variations, the collaboration system stores attributes for each participant either in the participant data structure or a separate data structure. In some variations, participant attributes include one or more: a host attribute (indicating whether the participant is the session host), a shared content attribute (identifying session content provided by the participant), a voting attribute (indicating a participant's vote (indicating a current voting response of the participant, e.g., as indicated by user input, gesture detection from the participants video camera, etc.)), a sentiment attribute (indicating a current sentiment of the participant, e.g., as indicated by user input, emotion detection from the participants video camera, etc.), a reaction attribute (indicating the participant's current reaction in the meeting, either specified via user input or detected by the collaboration system), a viewing attribute (indicating one or more content elements currently being viewed by the participant), a video/audio source attribute (indicating a location of the video and/or audio stream of the participant for the session), a participant identifier (identifying the participant by name or other form of identifier), a participant avatar attribute (identifying an avatar or icon used to visually represent the participant in the session), an annotations attribute (identifying or referencing ephemeral or persistent annotations made by the participant during the session), a cursor attribute (indicating a location of the participant's session cursor within the display area of the participants collaboration application, cursor color, etc.), a following attribute (indicating another participant that the participant is following), a followed by attribute (indicating one or more other participants that are following the participant), and a display configuration attribute (indicating an arrangement of one or more session content elements within a main display area of the participants collaboration application).

As participants join or leave the collaboration session, the collaboration system 110 updates the participant data structure accordingly (e.g., at S212).

In some variations, the collaboration system 110 updates the participant data structure as state of the collaboration session changes. In some variations, the collaboration system updates the participant data structure and provides at least one participant system with updated collaboration session state information when state of the collaboration session changes.

In some variations, the collaboration system determines whether a predetermined number or percentage of participants are viewing a given content element or group of content elements in a canvas (hereinafter referred to as collective content). In some variations, if the collaboration system determines that the predetermined number or percentage of participants are viewing the collective content, the collaboration system sends a notification to each participant system identifying the collective content. In some variations, if the collaboration system determines that the predetermined number or percentage of participants are viewing the collective content, the collaboration system updates the “viewing” attribute of each participant to identify the collective content, thereby automatically transitioning display of each participant system to display of the collective content. In some variations, the collaboration system determines the number or percentage of participants viewing the collective content by using the “viewing” attributes of the participant data structure.

In some variations, S213 functions to add one or more content elements to the collaboration session. S213 can be performed at any time, such as at the start of the collaboration session, during a collaboration session, in response to a trigger event, etc. S213 can include receiving content elements from one or more participant systems. In some variations, a participant system provides more than one content element. In some variations, a participant system provides more than two content elements. For example, a participant can control their participant system to provide a video camera stream, and screen shares for several applications simultaneously, such as a document viewer, a word processor, and a spreadsheet.

In some variations, at S213 the collaboration system 110 receives one or more content elements of the collaboration session from a collaboration application (e.g., 131-135) of the participant system. In some variations, a content module of the collaboration application (e.g., 131-135) provides at least one content element (e.g., by generating a content stream, by uploading a file, etc.). In some variations, the content module functions to generate a content stream by accessing stream data from the participant system (e.g., a system screen capture stream, an application output stream, a video camera stream, an audio stream, a voice chat stream, a data stream from a data source, etc.), encoding the stream data, and providing the stream data to the collaboration system 110. In some variations, the collaboration application (e.g., 131-135) provides at least one content element to the collaboration server 110 in response to receiving a “sharing” user input instruction. In some variations, the “sharing” user input instruction is an instruction to upload a single item (by uploading the item to the collaboration server or by streaming data of the item to the collaboration server). In some variations, the “sharing” user input instruction is an instruction to share a desktop screen (by providing a screen capture stream to the collaboration system). In some variations, the “sharing” user input instruction is an instruction to share an application (by providing an application output stream to the collaboration system). In some variations, the “sharing” user input instruction is an instruction to share a window displayed on the desktop of the participant system (by providing a window capture stream to the collaboration system).

In some variations, S215 functions to manage collaboration session content. S215 can be performed at any time, such as at the start of the collaboration session, during a collaboration session, in response to a trigger event, etc. In some variations, S215 functions to process collaboration session content.

In a first variation, the collaboration system 110 controls one or more display devices, and S215 includes the collaboration system 110 displaying collaboration session content at one or more display devices controlled by the collaboration system 110. In a second variation, the collaboration system 110 does not directly control display devices. In some variations, S215 includes one or more of encoding one or more content elements included in the collaboration session content. In some variations, S215 functions to generate at least one canvas based on the collaboration session content.

In some variations, S215 includes storing (in a memory, a non-volatile storage device, etc.) and maintaining at least one content data structure (e.g., a collaboration session data structure, or any suitable type of data structure) that includes content information for each content element. The content information can include information identifying a source location of the content element (e.g., a streaming source for streamed content, a storage location for a file, etc.) and one or more attributes for the content element. However, the content information can include any suitable type of information.

In some variations, content elements can be used by one or more collaboration sessions. For example, a participant that is participating in two separate collaboration sessions can share a content element in both sessions. As another example, a content element provided by a data storage system (e.g., a web site, a file server, etc.) can be included in a plurality of collaboration sessions. As content is added to or removed from the collaboration session, the collaboration system updates the content data structure accordingly (e.g., at S215).

In some variations, the collaboration system 110 maintains a content data structure for each collaboration session, each content data structure including attributes unique to the respective collaboration session. In some embodiments, the content data structure is global to all collaboration sessions, and includes attributes for each collaboration session in association with an identifier of the respective collaboration session. In some variations, the collaboration system 110 maintains a data structure that includes source locations of each content element, and a reference to one or more data structures that includes attributes for the content element (e.g., a reference to an attribute data structure for all sessions or a reference to an attribute data structure for each session).

However, content information for content elements can be otherwise managed using any suitable arrangement of data structures.

In some variations, one or more attributes of a content element are provided by a participant system (e.g., 121-125) (content owner) that provides the content element. In some variations, one or more attributes of a content element are provided by a participant system other than the participant system of the content owner. In some variations, one or more attributes of a content element are generated by the collaboration system 110. Content element attributes generated by the collaboration system 110 can include state attributes that indicate a state of the content element in the collaboration session and/or across all collaboration sessions of the collaboration system.

Content element attributes received from a content owner can include information identifying the participant providing the content element, and optionally access permissions for the content element (e.g., information indicating who can view, edit, or annotate the content element within the collaboration session). In some variations, content element attributes include one or more of display location (within a display area of one or more participant collaboration applications, e.g., 131-135), display size, a shared focus identifier (indicting that the content element has shared focus, e.g., as determined by the collaboration system, as determined by a host participant, or as determined by a user instruction received form a participant system), a viewer list (indicating which and/or how many participants are viewing the content element in the main display area of their respective collaboration application), an interaction list (indicating which and/or how many participants are interacting with the content element in their respective collaboration application), annotation information (identifying any annotations made to the content element by a collaboration application or by the collaboration system), an owner identifier identifying the participant providing the content element (e.g., a user of a participant system that provides the content), content access controls, and sentiment information (indicating a sentiment, comment, or feedback provided by at least one participant collaboration application for the content element). However, content element attributes can include any suitable attributes for content elements of the collaboration session.

In some variations, S220 functions to provide collaboration session state to at least one participant system (e.g., 121-125) (and/or another collaboration system). S220 can be performed at any time, such as at the start of the collaboration session, during a collaboration session, in response to a trigger event, in response to change in session state, etc. In some variations, collaboration session state includes at least one of: a content element included in the collaboration session content; at least one content element attribute for at least one content element included in the collaboration session; collaboration system input received by the collaboration system 110; participant information for one or more participants of the collaboration session; canvas information for at least one canvas of the collaboration session; a video camera stream of a participant; a microphone audio stream from a participant; and a voice chat audio stream for the collaboration session. However, the collaboration session state can include any suitable information.

In some variations, S220 includes providing all collaboration session content to each participant system (e.g., 121-125) of a participant of the collaboration session (e.g., as identified by the participant data structure).

In some variations, S221 includes selectively providing content elements of the collaboration session to each participant system of a participant of the collaboration session (e.g., as identified by the participant data structure) based on content access permissions (e.g., as specified by the content attributes).

In some variations, the collaboration system 110 provides each content element to each participant system of a participant of the collaboration session. In some variations, the collaboration system 110 generates a selection set of one or more content elements and provides each content element included in the selection set to each participant system of a participant of the collaboration session; and provides content representations of the other content elements to each participant system. In some variations, for each participant, the collaboration system 110 generates a selection set of one or more content elements and provides each content element included in the participant's selection set to the participant system of the participant; and provides content representations of the other content elements to the participant system.

In some variations, the collaboration system 110 streams each stream content element included in a selection set (e.g., a global selection set, a participant's selection set, a group's selection set, etc.) to one or more respective participants.

In some variations, at least one content element included in at least one selection set is a shared-focus content element. In some variations, each content element included in at least one selection set is a shared-focus content element.

In some variations, at least one selection set is a streaming set that includes stream content elements. In some variations, at least one selection set includes a combination of selected stream content elements and selected static content elements.

In a first example, at least one selection set includes a single content element. In a second example, at least one selection set includes a plurality of content elements

In some variations, the collaboration system 110 automatically generates each selection set. In some variations, the collaboration system 110 generates at least one selection set based on session state. In some variations, the collaboration system 110 generates at least one selection set based on collaboration session state (e.g., content element attributes, participant attributes, etc.). In some implementations, the collaboration system 110 selects content elements to be added to a selection set based on one or more of: a number of viewers viewing each content element, a shared focus of the collaboration session, a private focus of the collaboration session, content elements being viewed by a host of the collaboration session, content elements being shared by the host of the collaboration session, content elements being viewed by a current speaker, content elements being shared by a current speaker, etc. However, the collaboration system 110 can perform any suitable process for selecting content element streams (stream content elements).

In a first variation, for at least one selection set, the collaboration system 110 adds the last received content element to the selection set. In a second variation, for at least one selection set, the collaboration system adds the first received content element to the selection set. In a third variation, for at least one selection set, the collaboration system adds a content element provided by the host participant to the selection set. In a fourth variation, for at least one selection set, the collaboration system 110 adds each content element displayed in a main display area (e.g., 301 shown in FIG. 3A) of the collaboration application (e.g., 300 shown in FIG. 3A) of the host participant to the selection set. In a fifth variation, for at least one selection set, the collaboration system adds content elements to the selection set based on a user instruction received from at least one participant system. In some variations, the user instruction is provided by a content owner of the content element.

In a sixth variation, for at least one selection set, the collaboration system no generates the selection set based on collaboration session input received from one or more participant systems (e.g., at S230). In some implementations, session input used to generate a selection set includes at least one of: input selecting un-selected content elements, input de-selecting selected content elements, input identifying a sentiment for a content element, input identifying an annotation to a content element, input identifying pointer location of at least one participant, etc. In an example, a selection set for a first participant is updated based on session input received from other participants.

However, selection sets can be otherwise generated using any suitable input or state information.

By virtue of selecting one or more stream content elements, and only streaming the selected stream content elements, network resources can be more efficiently utilized and performance improvements may be realized as compared to streaming all stream content elements of the collaboration session to each participant system.

In some variations, the collaboration system 110 updates focus state information of the collaboration session (e.g., stored in a data structure) to include information identifying each content element included in a selection set.

In some variations, focus state information for the collaboration session identifies one or more content elements that are a focus of the collaboration session. The focus state information can identify one or more of: a focus for an individual participant; and a shared-focus for a plurality of participants. In a first example, a content element currently viewed (or shared) by a collaboration session host can be set as the shared-focus for the collaboration session. In a second example, one or more content elements included in a canvass of a collaboration session host can be set as the shared-focus for the collaboration session. In a third example, a content element selected by a participant can be set as a private focus for the participant selecting the content element.

In some variations, during establishment of the collaboration session, the collaboration server no sets the viewing attribute of each participant to identify each shared-focus content element as a currently viewed content element (currently viewed by the participant).

In some variations, session state provided at S220 can include visual representations of at least one participant of the collaboration session. In some variations, at least one visual representation of a participant is provided by the participant's collaboration application (e.g., 131-135). In some variations, at least one visual representation of a participant is generated by the collaboration system (e.g., by capturing an image of the participant's video stream, by generating an avatar, by using the participant's name or initials, etc.).

In some variations, a visual representation of a participant is a color identifying the participant. In some variations, a visual representation of a participant is a name identifying the participant. In some variations, a visual representation of a participant is an avatar identifying the participant. In some variations, at least one collaboration application (e.g., 131-135) uses visual representations of participants to identify at least one of a participant sharing a content element, a content element being viewed by a participant, an action being performed by a participant, a vote submitted by a participant, a sentiment submitted by a participant, a reaction submitted by a participant, and the like.

In some variations, session state provided at S220 can include one or more of: information included in a content data structure, information included in a participant data structure, and information included in a collaboration session data structure. However, session state can include any suitable information.

In some variations, the collaboration system 110 provides to participant systems (e.g., 121-125) of the collaboration session collaboration session state information that includes one or more of the following for the collaboration session: content elements (or representations of content elements) of the collaboration session, attributes of content elements of the collaboration system, identities and/or attributes of participants of the collaboration session, and visual representations of participants of the collaboration session. Content elements of the collaboration session can include video streams of participants of the collaboration session. Attributes of content elements can include annotation information. In some variations, the collaboration system provides collaboration input received from at least one participant system to each participant system of the collaboration session. In some variations, each participant system (e.g., 121-125) receives information from the collaboration system (e.g., no) via its respective collaboration application (e.g., 131-135).

S220 can include S225, which functions to provide canvas information to at least one participant. In some variations, canvas information identifies an arrangement within a canvas of content elements included a participant's selection set. In some variations, the canvas is a shared canvas shared by a plurality of participants. In some variations, the canvas is an individual canvas for a single participant. In some variations, the collaboration session state includes canvas information for a plurality of shared canvases, each shared canvas being shared by a respective set of participants of the collaboration session.

In some variations, S230 functions to access collaboration session input of one or more participants. S230 can be performed at any time, such as at the start of the collaboration session, during a collaboration session, in response to a trigger event, in response to receipt of session input by a participant system, etc.

S230 can include receiving collaboration input from at least one collaboration application (e.g., 131-135) participating in the collaboration session. In some variations, the collaboration application (e.g., 131-135) of a participant system generates collaboration input in response to receiving user input via a user input device of the processing system (e.g., 121-125). In some variations, session input is used at S240 to update collaboration session state, which is then provided to one or more participants (e.g., at S220).

S230 can include receiving, from each collaboration application (e.g., 131-135) of the collaboration session, collaboration input (view selection) that identifies one or more content elements currently being viewed by the respective participant. In some variations, processing view selection input includes receiving (from each collaboration application) information indicating user selection of a content element(s) being currently viewed, and updating collaboration session state to include information identifying the content element(s) being viewed by each participant. In some variations, the collaboration system 110 provides the updated collaboration session state to each collaboration application of the collaboration session. In some variations, each collaboration application updates content representations (e.g., 331 shown in FIG. 3A) of content elements and displayed content elements (e.g., 311-313 shown in FIG. 3A) to include visual indicators that identify participants viewing each content element (based on the updated collaboration session state received from the collaboration system). In this manner, view selection changes made by each participant are transmitted to the collaboration system 110, which then updates each participant with changes in view selection, to inform each participant in the collaboration session as to content elements being viewed by the other participants.

S230 can include receiving, from at least one collaboration application of the collaboration session, collaboration input (attribute update) that specifies at least one attribute value for at least one selected content element of the collaboration session. In some variations, processing an attribute update input includes receiving (from the collaboration application) information indicating user selection one or more attribute values for a selected content element, and updating collaboration session state to include the attribute value(s) provided by the attribute update input. In some variations, the collaboration system 110 provides the updated collaboration session state to each collaboration application of the collaboration session. In some variations, each collaboration application updates content representations of content elements and displayed content elements based on the updated collaboration session state received from the collaboration system. In this manner, attribute updates for a content element made by each participant are transmitted to the collaboration system 110, which then updates each participant with changes in content element attributes, to inform each collaboration application in the collaboration session as to the content element attribute changes. In some variations, the collaboration system 110 determines whether a participant requesting an attribute update for a content element is authorized to update attributes of the content element, and the collaboration system 110 performs the update responsive to a determination that the participant is authorized to make the update.

S230 can include processing collaboration input for participant selection and/or arrangement of the content elements within a participant's main display area (e.g., 301). In some variations, data indicating selection and/or arrangement of the content elements within the participant's main display area is provided by the respective collaboration application to the collaboration system 110, and the collaboration system stores this information as an attribute of the participant (e.g., in the participant data structure). In some variations, content elements included in the main display area of the collaboration application of the host participant are selected as the shared-focus content elements of the collaboration session, data indicating selection and arrangement of the content elements within the host participant's main display area is provided to the collaboration system 110, and the collaboration system updates focus state information to identify the selection and arrangement of content elements within the host participant's main display area as a current focus state. In some variations, the focus state information is not changed in response to changes to selection and/or arrangement of content elements within a main display area of a non-host participant's collaboration application. In some variations, an attribute update includes an update to access permissions for a content element.

S230 can include processing collaboration input for focus selection. In some variations, processing collaboration input for focus selection includes receiving information indicating user selection of a content element, and updating focus state information of the collaboration session to identify the selected content element as the current shared-focus content element. In some variations, a participant's collaboration application provides a focus input element for content shared by the participant. In some variations, a participant's collaboration application does not include a focus input element for content not shared by the participant. In some variations, the collaboration system determines whether a participant requesting focus selection is authorized to select focus (e.g., the participant is the owner of the selected content, the owner is the session host, etc.), and updates the focus state information responsive to a determination that the participant is authorized to select focus for the selected content.

S230 can include processing collaboration input for a participant's cursor (cursor input). In some variations, the cursor input for a participant's cursor indicates location of a participant's cursor in the main display area (e.g., 301 shown in FIG. 3A) of the participant's graphical user interface. In some variations, the cursor input identifies a content element in the main display area that is associated with the participant's cursor (e.g., identifies a region within a content element of the main display area that includes the participant's cursor). Processing cursor input can include processing cursor input for a plurality of participants for a same content element (e.g., several participants are collaborating by pointing to regions of a content element with their respective cursors). In some variations, the collaboration system 110 aggregates cursor input for each content element of a main display area across all participants, and updates collaboration session state to include information identifying the cursor locations of each participant for each content element included in a main display area of a collaboration application, and provides the updated session state to each participant. In this manner, each collaboration application can display the cursors of each participant viewing a content element in a main display region (e.g., as shown in FIG. 3B). In some variations, participant cursor movement within the secondary display area does not result in transmission of cursor information to the collaboration server 110.

S230 can include processing collaboration input for calling attention (group attention) to a selected content element (or a portion of a selected content element). In some variations, the collaboration input for calling group attention to a selected content element (or portion of the content element) specifies the content element, and optionally information indicating a specific portion of the content (e.g., a displayed portion of the content as indicated by a participant's cursor position). In some variations, the collaboration system 1120 processes group attention collaboration input by updating attribute information (e.g., at least one stored content element attribute) of the selected content element to include the specified group attention information, and providing the updated attribute information to each participant system, such that the collaboration application of each participant performs a process to call attention to the selected content element (or selected portion of the content element). In some variations, at least one collaboration application receiving group attention information for a content element (or selected portion) performs a process to call attention to the content element or selected portion by displaying an attention visual indicator on or around the content element (or selected portion). In some variations, the attention visual indicator is a spotlight indicator. In some variations, the attention visual indicator is a bounding box. In some variations, the attention visual indicator is a ring. In some variations, at least one collaboration application receiving group attention information for a content element (or selected portion) performs a process to call attention to the content element or selected portion by magnifying the content element (or selected portion).

S230 can include processing collaboration input for a content preview request (preview request) for a stream content element (e.g., that is not included in the selection set). In some variations, a preview request identifies a stream content element, and processing a preview request includes providing a live preview of the stream content element to the collaboration application that provides the preview request. In some variations, the stream content element identified in the preview request is displayed in the secondary display (e.g., 302) area as content representation (e.g., 331 shown in FIG. 3A), and not displayed in the main display area (e.g., 301), and upon receiving the stream data of the live preview, the collaboration application displays the live preview in place of the content representation.

S230 can include processing collaboration input for adding a content element to the main display area (view request). In some variations, the collaboration application of a participant system generates a view request in response to user input to select a content representation (e.g., 331) included in the secondary display area (e.g., 302) (e.g., a drag-and-drop operation to drag the content representation to the main display area, selection of the content representation in connection with a “share” or “focus” operation, etc.).

In a first variation, the view request is provided in connection with a focus operation, and the view request identifies the content element and specifies that the shared focus should be set to include the identified content element; the collaboration system 110 processes the request by updating focus state information to specify the content element of the view request, thereby updating the main display area of each collaboration application following the shared focus; in a case where the content element is a stream content element, the collaboration server 110 also provides the stream content element to each participant system.

In a second variation, the view request is provided in connection with a private viewing operation (which does not change the shared focus) in which the selected content element is a stream content element, and the view request identifies the content element, and the collaboration server 110 provides the stream content element to the requesting participant system. In some variations, the collaboration application does not send a view request to the collaboration server 110 if the collaboration application already has the full content element (e.g., the content element is a static content element, or the collaboration system already has current stream data for a stream content element) and the collaboration application is not attempting to update the shared focus.

S230 can include processing collaboration input for removing a content element from the main display area. In some variations, the collaboration application of a participant system generates a view request in response to user input to select a content element included in the main display area (e.g., 301) (e.g., a drag-and-drop operation to drag the content element from the main display area to the secondary display area, selection of the content element in connection with a “stop sharing” operation, etc.).

In some variations, the removal request is provided in connection with a main display area arrangement operation performed by a host participant in which two or more content elements are displayed in the main display area, and the removal request identifies the content element; the collaboration system 110 processes the removal request by updating the host participant attributes (participant state information) to specify the updated arrangement of the host participant's main display area, and the collaboration system provides collaboration session state indicating the updated arrangement to each participant system. In this manner, the main display area of participants following the host participant is updated to match the main display area of the host participant.

S230 can include processing collaboration input for adding a content element to the collaboration session. Processing collaboration input for adding a content element to the collaboration session includes receiving a content element from a participant system (that provides the collaboration input for adding content), and adding the content element to the content of the collaboration session, as described herein. The collaboration system 110 provides the added content element (or a content representation of the content element) to each participant system (or each participant system authorized to receive the content element). In some variations, the collaboration input for adding the content element includes authorization information that identifies participants authorized to receive the content element, and the collaboration system 110 provides the added content element to each participant system authorized to receive the content element. In this manner, participants can share content among sub-groups of participants.

S230 can include processing collaboration input for removing a content element from the collaboration session. Processing collaboration input for removing a content element from the collaboration session includes removing a content element identified by the collaboration input from the content of the collaboration session; the collaboration system 110 also provides instructions to each collaboration application to remove the content element from the graphical user interface (e.g., 300).

S230 can include processing collaboration input for a shared canvas controlled by one or more participants (e.g., as shown in FIG. 3A). In some variations the collaboration input for the shared canvas identifies participants authorized to control the canvas. In response to a collaboration input for a shared canvas, the collaboration system 110 records state for the shared collaboration environment that includes the participants controlling the shared canvas and content elements included in the shared canvas. User input to add, remove, or arrange content elements in the shared canvas by participants authorized to control the shared canvas is provided by the respective collaboration application to the collaboration system 110, which forwards the user input to the collaboration applications of participants following the shared canvas. In this manner, the main display areas of all participants following the shared canvas displays the same content element in the same arrangement. In some variations, user selection of a content element in the shared canvas results in the corresponding collaboration application sending a focus request to the collaboration system, which forwards focus information to each collaboration application of a participant following the shared canvas. Each such collaboration application then updates display of the focused content element to indicate its selection by the selecting participant. In this manner, a participant can point out a content element within the shared canvas to other participants in the collaboration session.

In some variations, a content element is a screen share of an application (application content element), and the collaboration system receives a collaboration input for adding a screen share of an application to the collaboration session. In some variations, each collaboration application displays each screen share of an application in the main display area as an interactive application, such that participants can interact with the application via the collaboration application. In some variations, the collaboration application (in conjunction with the collaboration system) provides remote desktop functionality for each application content element (e.g., in accordance with a remote desktop protocol).

S230 can include processing collaboration input for a share request. In some variations, the share request specifies the identity of the participant requesting to share, and the share request identifies the content element of the collaboration session that is to be shared (e.g., a content element that is included in the collaboration session but is not currently being viewed, or is not currently included in a shared canvas). In some variations, the collaboration application provides a share user interface element only for content elements owned by the corresponding participant. In some variations, the collaboration system 110 processes a share request by providing the share request notification to all participant systems. In some variations, in a collaboration application of a participant system receiving a share request updates display of the content representation of content element (requested to be shared) in the secondary display area by either updating the visual appearance or by animating the visual representation.

S230 can include processing collaboration input for annotation of a selected content element. In some variations, the collaboration input for annotation of a selected content element specifies the content element to be annotated, and annotation information (e.g., drawing information, etc.). In some variations, the collaboration system 110 processes annotation collaboration input by updating attribute information (e.g., at least one stored content element attribute) of the selected content element to include the specified annotation information, and providing the updated attribute information to each participant system, such that the collaboration application of each participant displays the annotations. In some variations, the collaboration system 110 processes user input for ephemeral annotations (that are momentarily displayed and then vanish) and user input for persistent annotations (that remain with the content element). In some variations, when processing user input for an ephemeral annotation, the collaboration system 110 updates the collaboration session state with information indicating that the annotation is ephemeral, so that the collaboration applications can display the annotation as an ephemeral annotation (e.g., as shown in FIG. 3C). In some variations, when processing user input for a persistent annotation, the collaboration system stores the annotation in association with the content element, and, optionally, information identifying the collaboration session during which the content element is updated.

In some variations, the updated attribute information provided to each participant system includes display information indicating how the annotation information should be displayed, such that the collaboration application of each participant displays the annotations in accordance with the display information. In some variations, display information specifies when the annotation should disappear. In a first example, annotations disappear on a fixed timeout. In a second example, annotations disappear based on signal processing of the associated content element. In a third example, annotations disappear when the associated content element is no longer being displayed in the main display area. In a fourth example, annotations disappear when the associated content element is no longer being displayed in the secondary display area. In a fifth example, annotations disappear when there are no participants viewing the associated content element. In a sixth example, annotations disappear when they are explicitly cleared either via a local clear instruction received by the collaboration application or by a collaboration input received by the collaboration system.

S230 can include processing collaboration input for a sentiment (or reaction). In some variations, the collaboration input for a sentiment identifies the participant making the sentiment, and specifies a sentiment (e.g., “raise hand”, “I love it!”, “Not sure”, “I'm confused”, “I disagree”). FIG. 3F shows a sentiment button 394f for receiving collaboration input for a sentiment. FIG. 3D shows a visual representation of a sentiment 399d received from a participant's collaboration application. FIG. 3G shows a sentiment button 393g for receiving collaboration input for a sentiment, and a visual representation of a sentiment 392g received from a participant's collaboration application. In some variations, the collaboration input for a sentiment also specifies a content element related to the sentiment. In some variations, the collaboration system 110 processes sentiment collaboration input by updating stored attribute information of the participant providing the sentiment to include the specified sentiment (and, optionally, information identifying a related content element), and providing the sentiment information to each participant system, such that the collaboration application of each participant displays the sentiment in association with the participant (e.g., displays a sentiment emoji, animation, textual description, image, etc. next to a visual representation of the participant) (e.g., as shown in FIG. 3D).

In some variations, the collaboration input for a sentiment specifies a content element related to the sentiment (and optionally a location on or near a visual representation of the specified content element), the collaboration system provides the sentiment information to each participant system, and at least one collaboration application displays the sentiment in association with the content element (e.g., displays a sentiment emoji, animation, textual description, image, etc.). In some variations, collaboration applications displaying sentiments based on received sentiment information can display a visual representation of the sentiment at a location identified by the sentiment information (e.g., the on or near a visual representation of the content element, etc.). In a case where several participants provide sentiment collaboration input for a same content element, at least one collaboration application displays visual representations of the sentiments of each of the participants in association with the content element (e.g., at locations identified by the sentiment information for sentiments of one or more participants). In this manner, a participant can easily identify sentiments for a content element provided by all of the participants.

In some variations, the collaboration input for a sentiment identifies a visual indicator for a sentiment of another participant; the sentiment information provided by the collaboration system 110 to each participant system identifies the sentiment visual indicator of the sentiment collaboration input; at least one collaboration application updates the visual indicator identified by the collaboration input to indicate that it has been “echoed” by another participant. Updating the visual indicator of the sentiment can include at least one of enlarging the visual indicator, changing a color of the visual indicator, increasing a numerical counter of the visual indicator, updating a number badge of the visual indicator, or performing any other suitable type of visual treatment.

S230 can include processing collaboration input for a voting response. In some variations, the collaboration input for a voting response identifies the participant making the voting response, and specifies a voting response. In some variations, a voting response can include one or more of a gesture recognized from the participant's video camera (e.g., thumbs up or thumbs down), a numerical rating (e.g., 1-10), an alphabetic rating (e.g., A-Z), a binary rating (e.g., yes/no, hot/cold), a multiple choice rating value, a dot voting value, a sliding scale value, as well as domain specific types such as scrum “planning poker”, and the like. In some variations, the collaboration input for a voting response also specifies a content element related to the voting response (and optionally a location on or near a visual representation of the specified content element). In an example, a visual representation of the specified content element identifies a voting choice, or selection of possible voting choices, and a voting response is identified by a location on visualization representation of the content element; in such a case, the location representing the voting response is included in the collaboration input for the voting response. In some variations, the collaboration system 110 processes voting response collaboration input by updating stored attribute information of the participant providing the voting response to include the specified voting response (and, optionally, information identifying a related content element), and providing the voting response information to each participant system, such that the collaboration application of each participant displays the voting response in association with the participant (e.g., displays a sentiment emoji next to a visual representation of the participant).

S230 can include processing collaboration input for an emotion. In some variations, the collaboration application of at least one participant system receives video data of a participant's face. In a first variation, the collaboration application includes an emotion detection module and uses the emotion detection module to continuously monitor emotion and update an emotion identifier; in response to change in emotion, the collaboration application provides an emotion update collaboration input to the collaboration system 110. In response, the collaboration system 110 processes emotion update collaboration input by updating stored attribute information of the participant (that is providing the emotion update) to include the specified emotion update, and providing the emotion update information to each participant system, such that the collaboration application of each participant displays the updated emotion in association with the participant (e.g., updates the visual representation of the participant to reflect the change in emotion). In some variations, the collaboration system receives the video data of the participant's face and performs the emotion detection.

In some variations, S230 can include processing collaboration input for a follow request to follow a participant. In some variations, the collaboration system processes a follow request by updating attribute information (e.g., a “following” attribute as described herein) of the participant requesting to follow with information identifying the participant to be followed, such that the collaboration system provides the participant requesting to follow with information identifying a content element(s) currently being viewed by the participant to be followed. In some variations, the collaboration system 110 processes a follow request by updating attribute information (e.g., a “followed by” attribute as described herein) of the participant to be followed.

In some variations, an inviting participant (e.g., a host, a non-host) submits a notification to the collaboration system 110 to notify the other participants that the inviting participant is inviting all participants to follow the inviting participant, and thus prompt the other participants to submit to the collaboration system a collaboration input for following the inviting participant. In some variations, an inviting participant (e.g., a host, a non-host) can submit a “follow me” collaboration input to the collaboration system. In some variations, the collaboration system processes a “follow me” collaboration input by updating the “following” attribute of each participant to identify the inviting participant (e.g., a host). In some variations, the “follow me” collaboration input specifies one or more participants, and the collaboration system processes the “follow me” collaboration input by updating the “following” attribute of each participant specified by the “follow me” collaboration input to identify the inviting participant (e.g., a host). In this manner, a host can force one or more participants to follow the host.

In some variations, the collaboration system provides the participant requesting to follow with content streams(s) currently being viewed by the participant to be followed, and provides content representations of the other content elements that are not currently being viewed by the participant to be followed.

In some variations, a following participant's collaboration application displays the same display output (e.g., screens, canvases, content elements, content representations, video conferencing output, main display area, secondary display area, etc.) that is being displayed by the collaboration application of the participant being followed.

S240 functions to provide updated collaboration session state to one or more participants. S240 can be performed at any time, such as at the start of the collaboration session, during a collaboration session, in response to a trigger event, in response to change in session state, etc.

S240 can include adding a content element to a selection set based on session input identifying annotation to the content element.

In some variations, the collaboration system 110 provides updated collaboration session state to each participant system in response to a change in collaboration session state (e.g., in response to collaboration session input accessed at S230). In some variations, the collaboration session state identifies what each participant is viewing, and a collaboration application can process a follow request received via a user input device of the respective participant system by updating display of the main display area based on content being viewed by the participant to follow, as indicated by the collaboration session state information received from the collaboration system.

FIG. 3B shows a main display area that includes a single content element, in which two participants are interacting with the displayed content element by using respective cursors. As shown in FIG. 3B, the secondary display area is not shown during this collaboration operation.

FIG. 3C shows an annotation made by participant 2.

FIG. 3D shows a visual representation 399d of a sentiment provided by participant 2.

FIG. 3E shows a shared work environment in which the collaboration application overlays content elements (e.g., 398e, 397e), and user interface elements (e.g., 396e, 395e) of the graphical user interface on top of the participant's desktop 394e. As shown in FIG. 3E, the participant's desktop is visually diminished. In some variations, the graphical user interface provides a shared canvas, as described herein. In some variations, the participant's desktop is visible, but visually diminished. In some variations, the content elements (e.g., 398e, and 397e) include interactive applications (as described herein). In some variations, any participant can select an interactive application content element provided by another participant and take over control of interaction with the application. In some variations, the collaboration application 110 provides visual indicators of each participant interacting with the interactive application content element. In some variations, the collaboration application detects user selection of local windows of the participant's desktop, and responsive to such detection, the collaboration application generates an interactive application content element for the selected local window (e.g., by using a remote desktop protocol) and provides the content element to the collaboration system.

FIG. 3F shows a sentiment/reaction button 394f that receives user selection of a sentiment or reaction to be shared with the participants in the collaboration session via the collaboration system 110.

FIG. 3G shows a sentiment/reaction feed 391g that includes visual representations of each participant. In some variations, a participant's collaboration application displays a sentiment button (e.g., 393g) next to the visual representation of the participant in the feed, and the sentiment button receives user selection of a sentiment or reaction to be shared with the participants in the collaboration session via the collaboration system 110. In some variations, a visual indicator (e.g., 392g) of each participant's sentiment is displayed in association with the respective participant representation. In some variations, the visual representation of the active speaker is arranged at the top of the sentiment feed. In some variations, the visual representations of the participants in the sentiment feed are arranged based on recency of reaction (as indicated by collaboration session state received from the collaboration system). In some variations, a participant can select a “raise hand” reaction, and the collaboration system updates session state such that each collaboration application arranges the visual representation of the participant selecting the “raise hand” reaction to be below the visual representation the active speaker.

### 4. CONCLUSION

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the disclosed embodiments without departing from the scope of this disclosure defined in the following claims.

We claim:

1. A method comprising: with a collaboration system:
starting a collaboration session;
adding a plurality of participants to the collaboration session;
receiving a plurality of stream content elements from one or more participant systems of the participants;
adding the received stream content elements to the collaboration session;
for at least one participant:
selecting a streaming set of stream content elements and a content representation set of stream content elements from the stream content elements added to the collaboration session,
streaming each stream content element included in the streaming set to the participant system of the participant, and
providing a content representation of each stream content element included in the content representation set to the participant system of the participant.

2. The method of claim 1, wherein selecting a streaming set of content elements and a content representation set of content elements comprises: adding the last stream content element received by the collaboration system to the streaming set, and adding any remaining stream content elements to the content representation set.

3. The method of claim 1, wherein selecting a streaming set of stream content elements and a content representation set of stream content elements comprises: adding the first stream content element received by the collaboration system to the streaming set, and adding any remaining stream content elements to the content representation set.

4. The method of claim 1, further comprising: with the collaboration system:
receiving collaboration session input from one or more participant systems;
for at least one participant:
updating at least the streaming set based on the received collaboration session input, and
streaming each stream content element included in the updated streaming set to the participant system of the participant.

5. The method of claim 4, wherein updating at least the streaming set based on the received collaboration session input comprises updating the streaming set of a first participant based on session input received from at least a participant system of a second participant.

6. The method of claim 4, wherein collaboration session input received from at least one participant system identifies at least one of: input selecting a content element, input de-selecting a content element, input identifying a sentiment for a content element, input identifying an annotation to a content element, and input identifying pointer location of the participant.

7. The method of claim 6, wherein updating at least the streaming set based on the received collaboration session input comprises: moving a content element from the content representation set to the streaming set based on session input identifying annotation to the moved content element, received from at least one of the participant systems.

8. The method of claim 5,
further comprising: with the collaboration system, managing collaboration session state for the collaboration session,
wherein the streaming set for at least one participant includes a plurality of content elements, and the content representation set for at least one content participant system includes a plurality of stream content elements.

9. The method of claim 8, wherein for at least one participant, the collaboration session state includes canvas information identifying an arrangement of the stream content elements included in the participant's streaming set within a canvas.

10. The method of claim 9, wherein the canvas is a shared canvas shared by a plurality of participants.

11. The method of claim 9, wherein the canvas is an individual canvas for a single participant.

12. The method of claim 9, wherein the collaboration session state includes canvas information for a plurality of shared canvases, each shared canvas being shared by a respective set of participants of the collaboration session.

13. The method of claim 1, further comprising: with the collaboration system:
receiving a video camera stream from one or more participant systems of the participants; and
providing each received video camera stream to each participant system.

14. The method of claim 1, further comprising: with the collaboration system:
receiving a microphone audio stream from a plurality of participant systems of the participants;
generating a voice chat audio stream by combining microphone audio streams received from the participant systems; and
providing the voice chat audio stream to each participant system.

15. The method of claim 1, further comprising: with the collaboration system:
receiving collaboration session input from at least one participant system;
providing at least a portion of the received collaboration session input to at least one participant system.

16. The method of claim 15, wherein collaboration session input received from at least one participant system identifies at least one of: input selecting a content element, input de-selecting a content element, input identifying a sentiment for a content element, input identifying an annotation to a content element, input identifying pointer location of the participant, and input identifying arrangement of content elements in a canvas.

17. The method of claim 1, further comprising: with the collaboration system:
managing participant attributes of the participants; and
providing participant attributes of one or more participant to at least one participant system.

18. The method of claim 17, wherein participant attributes for a participant include at least one of:
a host attribute indicating whether the participant is the session host;
a shared content attribute identifying at least one content element provided by the participant;
a voting attribute indicating a participant's vote;
a sentiment attribute indicating a current sentiment of the participant;
a reaction attribute indicating the participant's current reaction in the collaboration session;
a viewing attribute indicating one or more content elements currently being viewed by the participant;
a participant identifier;
a participant avatar attribute;
an annotations attribute identifying annotations made by the participant during the collaboration session;
a cursor attribute indicating a location of the participant's session cursor within a display area of a collaboration application of the participant;
a following attribute indicating another participant that the participant is following;
a followed by attribute indicating one or more other participants that are following the participant; and
a display configuration attribute indicating an arrangement of one or more stream content elements included in the participant's streaming set within a main display area of the participant's collaboration application.

19. The method of claim 1, wherein content representations include one or more of: images; icons; thumbnails; textual descriptions; reduced resolution streams; reduced size streams; and animated images.
